(19) United States
(12) Patent Application Publication
(10) Pub. No.: US 2023/0214755 A1
(43) Pub. Date: Jul. 6, 2023

(54) SYSTEMS FOR OPTIMIZING A DELIVERY PROCESS

(71) Applicant: Michael Salomon, Tuscon, AZ (US)

(72) Inventor: Michael Salomon, Tuscon, AZ (US)

(21) Appl. No.: 18/148,917

(22) Filed: Dec. 30, 2022

Related U.S. Application Data
(60) Provisional application No. 63/266,255, filed on Dec. 30, 2021.

(51) Int. Cl. G06Q 10/0639; G06Q 10/083

(52) U.S. Cl. CPC G06Q 10/06393; G06Q 10/083

(57) ABSTRACT

Systems for optimizing a delivery process according to various aspects of the present technology may comprise a user device, a ranking engine, a delivery driver management platform communicatively linked to the ranking engine, a database, a server, and a display. The user device may be configured to receive customer data and delivery driver data. The ranking engine may be configured to compute a plurality of rank scores according to the customer data and the delivery driver data. The ranking engine may also be configured to generate a plurality of customer profiles and a plurality of delivery driver profiles according to the customer data and the delivery driver data, respectively. The ranking engine may be further configured to store the plurality of delivery driver profiles and the plurality of rank scores in the database. The server may be communicatively linked to the database over a communication network, wherein the server may be provided with access to the plurality of customer profiles, the plurality of delivery driver profiles, and the plurality of rank scores. The display may be configured to present the plurality of delivery driver profiles according to the plurality of rank scores.

### CROSS REFERENCE TO RELATED APPLICATION[S]

This application claims priority to U.S. Provisional Patent Application entitled “SYSTEMS FOR OPTIMIZING A DELIVERY PROCESS,” Ser. No. 63/266,255, filed Dec. 30, 2021, now pending the disclosure of which is hereby incorporated entirely herein by reference.

### BACKGROUND OF THE TECHNOLOGY

Order delivery or takeout systems can be used by a customer to order delivery or takeout from a food provider, such as a restaurant, grocery store, convenience store, etc. In the event the customer places a takeout order, the customer can pick a meal and/or beverage up from the food provider. Alternatively, in the event the customer places a delivery order, a delivery driver can deliver the meal and/or beverage to the customer's address.

Conventional delivery systems are typically limited to the food service industry and automatically assign a delivery driver to each incoming order without considering the delivery driver's availability, geographical location, traffic patterns, road construction, and the like. In this regard, the delivery driver assigned to a particular incoming order may not be best suited for delivering the meal and/or beverage associated with that order to the customer in a timely and efficient manner.

Accordingly, what is needed is a delivery system that is applicable to both food and non-food delivery processes and that allows for each incoming order to be delivered to the correct customer in a timely and efficient manner while providing the customer with the flexibility to choose a delivery driver and while providing the delivery driver with the flexibility to set his own prices.

### SUMMARY OF THE TECHNOLOGY

Systems for optimizing a delivery process according to various aspects of the present technology may comprise a user device, a ranking engine, a delivery driver management platform communicatively linked to the ranking engine, a database, a server, and a display. The user device may be configured to receive customer data and delivery driver data. The ranking engine may be configured to compute a plurality of rank scores according to the customer data and the delivery driver data. The ranking engine may also be configured to generate a plurality of customer profiles and a plurality of delivery driver profiles according to the customer data and the delivery driver data, respectively. The ranking engine may be further configured to store the plurality of delivery driver profiles and the plurality of rank scores in the database. The server may be communicatively linked to the database over a communication network, wherein the server may be provided with access to the plurality of customer profiles, the plurality of delivery driver profiles, and the plurality of rank scores. The display may be configured to present the plurality of delivery driver profiles according to the plurality of rank scores.

### BRIEF DESCRIPTION OF THE DRAWINGS

A more complete understanding of the present technology may be derived by referring to the detailed description and claims when considered in connection with the following illustrative FIGURE. In the following FIGURE, like reference numbers refer to similar elements and steps throughout the FIGURE.

FIG. 1 is a block diagram of a system for optimizing a delivery process in accordance with an embodiment of the present technology.

### DETAILED DESCRIPTION OF EMBODIMENTS

The present technology may be described in terms of functional block components. Such functional blocks may be realized by any number of components configured to perform the specified functions and achieve the various results. For example, the present technology may employ various communication networks, databases, displays, graphical user interfaces, engines, platforms, servers, and user devices, which may carry out a variety of functions. In addition, the present technology may be used for any suitable food-delivery process, and the system described is merely one exemplary application for the technology. Alternative embodiments may be applicable to non-food delivery processes, such as delivery processes for letters, packages, ordered goods, and the like.

The present technology may be practiced in conjunction with any number of systems for providing a computer-implemented system for optimizing a delivery process. Further, the present technology may employ any number of conventional techniques for receiving, storing, transmitting, and displaying data.

The particular implementations shown and described are illustrative of the technology and its best mode and are not intended to limit the scope of the present technology in any way. Indeed, for the sake of brevity, conventional manufacturing, connection, preparation, and other functional aspects of the system may not be described in detail. Furthermore, the connecting lines shown in the various FIGURES are intended to represent exemplary functional relationships. Many alternative or additional functional relationships or physical connections may be present in a practical system.

Various representative algorithms may be implemented with any suitable combination of data structures, objects, processes, routines and/or other programming elements. Software and/or software elements according to various aspects of the present technology may be implemented with any suitable programming or scripting language, such as C, C++, Java, PERL, PHP, and the like. Further, the present technology may employ any number of conventional techniques for data transmission, signaling, data processing, network control, and the like.

According to various aspects of the present technology, a user may interact with the system by any input device such as a keyboard, a mouse, a handheld computer, a cellular phone such as a Smartphone that may have access to the Internet, and the like. Similarly, the present technology may be used in conjunction with any type of personal computer, network computer, workstation, minicomputer, or the like running any operating system such as any version of Windows, MacOS, or any other operating system, whether now known or known hereafter in the art. Moreover, the present technology may be implemented with TCP/IP communications, IPX, OSI or any number of existing or future protocols.

The present technology may be embodied as a method, a system, a device, and/or a computer program product. Accordingly, the present technology may take the form of a software embodiment, a hardware embodiment, or an embodiment combining aspects of both software and hardware. Furthermore, the present technology may take the form of a computer program product on a computer-readable storage medium having computer-readable program code embodied in the storage medium.

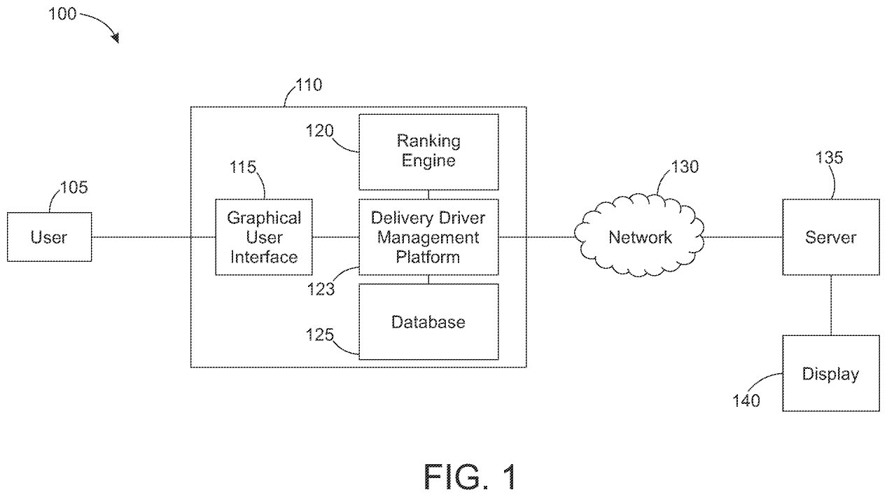

Referring to FIG. 1, systems for optimizing a delivery process according to various aspects of the present technology may be representatively illustrated by a system 100 for access by a user 105. The user 105 may be any suitable person, such as a customer, a delivery driver, and the like. The system 100 may comprise a user device 110, which may comprise a graphical user interface 115, a ranking engine 120, a delivery driver management platform 123, and a database 125. The system 100 may also comprise a communication network 130, a server 135, and a display 140.

According to various embodiments, the graphical user interface 115 may be configured to receive user data from the user 105. The graphical user interface 115 may comprise any suitable system for communicating, accessing, updating, exchanging, organizing, and/or managing information such as by data collection, encryption, acquisition, storage, dissemination, and the like. In one embodiment, the graphical user interface 115 may comprise a mobile device interface. In another embodiment, the graphical user interface 115 may comprise a website interface.

According to various embodiments, the user 105 may access the graphical user interface 115 by entering an email address, username, password, and/or pin into the graphical user interface 115. Once the user 105 accesses the graphical user interface 115, the user 105 may enter the user data, such as identifying information about the user 105, into the graphical user interface 115. The identifying information may comprise any suitable information associated with the identity of the user 105. For example, in the case where the user 105 is a customer, the identifying information may comprise the customer's first name, last name, and address (i.e., the “customer data”). The customer data may also include other information, such as a plurality of first distances, where each first distance is equal to a distance between a pickup location (i.e., address of the restaurant) and a delivery location (i.e., address of the customer). The customer data may further comprise a plurality of customer payment information, a plurality of customer contact information, and a plurality of desired service requests. The plurality of desired service requests may include any suitable request, such as a desired delivery time, cooking instructions and/or special requests regarding menu selections, and the like.

In the case where the user 105 is a delivery driver, the identifying information may comprise the delivery driver's first name, last name, photo, license plate number, reviews, age, gender, and any other suitable information, such as specific restaurants that the delivery driver chooses not to pick up food from (i.e., the “delivery driver data”). The delivery driver data may also comprise a plurality of second distances, where each second distance is equal to a distance between the real-time geographic location of one of the plurality of delivery drivers and the pickup location. The delivery driver data may further comprise a plurality of mileage rates.

It will be appreciated that the delivery driver's mileage rate may comprise any suitable rate. For example, the delivery driver may charge $3.00 for the first three miles traveled and an additional $0.50 for every mile traveled thereafter. Alternatively, the delivery driver may charge a flat rate, such as $5.00, for any trip that is 8 miles or less. It will also be appreciated that the system 100 may compute the delivery driver's mileage rate based on a variety of suitable parameters, such as the delivery driver's geographical location, traffic patterns, road construction, expenses, the driving distance between the delivery driver and the customer's address, and the like. It will be further appreciated that the aforementioned parameters may be received by the system 100 from the customer and/or delivery driver.

According to various embodiments, the customer data may be used to create a profile of the customer, and the delivery driver data may be used to create a profile of the delivery driver. The customer's profile and the delivery driver's profile may each be saved to the database 125. If the customer data changes at a later time, the customer's profile may be updated and saved to the database 125 to reflect the changes. Similarly, if the delivery driver data changes at a later time, the delivery driver's profile may be updated and saved to the database 125 to reflect the changes.

The delivery driver management platform 123 may be communicatively linked to the graphical user interface 115 and the ranking engine 120. The delivery driver management platform 123 may also be communicatively linked to the display 140. The delivery driver management platform 123 may be configured to recommend a list of “food providers” to the customer via the graphical user interface 115. For the purposes of this application, the term “food provider” means any vendor, business, organization, entity, group or individual, and/or retail food establishment that provides food or beverage to the public. As an example, the customer may be provided with a list of restaurants, chefs, markets, food trucks, and the like. The display 140 may present a variety of information about the food providers, such as the type of food and/or beverages each food provider offers, along with a variety of menu options that the customer may select from.

The customer may make one or more menu selections by clicking on an “Add +” button located next to the menu option. After the customer makes one or more menu selections, the customer may proceed to checkout by clicking on a “Continue” button. After the customer clicks the “Continue” button, the customer may be given the option to provide cooking instructions and/or special requests regarding the one or more menu selections, so that the customer's food may be prepared and delivered in accordance with the transmitted instructions. The customer may also be prompted to apply a promo code or coupon, if applicable, to reduce the total cost of the order.

In addition, the system 100 may recommend one or more delivery drivers to the customer, so that the customer may select a delivery driver from the plurality of delivery drivers. Specifically, the ranking engine 120 may retrieve the customer profile and the plurality of delivery driver profiles and analyze the identifying information associated with the customer profile and each delivery driver profile along with any other suitable information, such as the driver's geographical location, traffic patterns, road construction, and the like. The ranking engine 120 may be configured to automatically or upon initiation by the user 105 perform processing of the identifying information and any other suitable information to compute a rank score for each delivery driver profile and then sort the delivery driver profiles by their relevance. The ranking engine 120 may then transmit the plurality of rank scores to the delivery driver management platform 123 which in turn assigns the plurality of rank scores to the plurality of delivery driver profiles and compares the plurality of delivery driver profiles according to the plurality of rank scores. In addition, the delivery driver management platform 123 may transmit the plurality of delivery driver profiles and the plurality of rank scores to the display.

The display 140 may present the delivery drivers to the customer in an improved manner, such as by displaying the most relevant delivery driver profiles at the top of the display 140 and the less relevant delivery driver profiles at the bottom of the display 140. In one embodiment, the display 140 may present the three most relevant delivery drivers, which may be determined according to the aforementioned information received by the system 100 from the customer and/or delivery driver. It will be appreciated that the aforementioned information may comprise a minimum and/or maximum travel distance, base price, and any other suitable information. Because the delivery driver profiles are not selected and presented to the customer in a random manner (e.g., when the delivery drivers are not available to perform the delivery services) but are instead selected and presented to the customer based on the availability of the delivery drivers and the capability of the delivery drivers to meet the customer order or request prior to the time the customer order or request is made, the system 100 may reduce latency between the time the customer submits or transmits the customer order or request and the time a delivery driver accepts the customer order or request.

The rank score may be a low rank score, a moderate rank score, or a high rank score and may indicate whether a delivery driver is suited for a particular delivery. The higher the rank score, the better suited the delivery driver is to deliver the food to the customer. In contrast, the lower the score, the less suited the delivery driver is to deliver the food to the customer. The rank score may be a weighted score and may be computed by attributing a predetermined weight (i.e., number of points) to each of a variety of variables, such as the delivery driver's mileage rates, geographical location, and the like. The weight attributed to each variable may depend on the variable itself. For example, some variables, such as the mileage rates of the delivery driver, may be given more weight than other variables, such as the geographical location of the delivery driver.

In addition, the weight attributed to a variable associated with one delivery driver may be different than the weight attributed to the same variable associated with a different delivery driver. For example, the weight attributed to the geographical location variable associated with a first delivery driver may be greater than the weight attributed to the geographical location variable associated with a second delivery driver if the first delivery driver is geographically closer to the customer than the second delivery driver. The points may be summed to compute the rank score.

It will be appreciated that modifications may be made to the system 100 without departing from the scope of the present invention. For example, instead of computing each rank score by attributing a predetermined weight to each of the variables, the ranking engine 120 may compute the plurality of rank scores by attributing a user-selected weight to each of the variables.

In one embodiment, the ranking engine 120 may compute the plurality of rank scores based on at least one of a plurality of factors, including the plurality of first distances, the plurality of second distances, the plurality of mileage rates, a plurality of traffic conditions between the pickup location and the delivery location, and a plurality of weather conditions between the pickup location and the delivery location. The ranking engine 120 may assign a plurality of number values to the plurality of factors. Each factor may be assigned a number value comprising at least one of a first number value, a second number value, a third number value, or a fourth number value. Each number value may comprise any suitable number value, such as 1, 2, 3, 4, and the like, and may depend on the factor or the plurality of desired services requests. Additionally, the ranking engine 120 may assign a respective one of a plurality of weighted values to each number value. The weighted values may comprise any suitable fraction, ratio, or percentage. Furthermore, the weighted values may be predetermined.

After the customer selects the delivery driver from the plurality of delivery drivers, the customer may check out by clicking on a “Process to Pay” button, which may be located at the bottom of the display 140. After the customer checks out, the ranking engine 120 may retrieve the customer data and transmit the customer data to the food provider and the selected delivery driver. In this regard, the food provider may utilize the customer data to optimize resource allocation and/or delivery allocation, and the selected delivery driver may be notified that an order was made. The display 140 may present the customer data to the food provider and the selected delivery driver.

According to various embodiments, the database 125 may be accessible to the ranking engine 120. In particular, the database 125 may be communicatively linked to the ranking engine 120. The database 125 may be configured to securely store the customer data, customer profile, delivery driver data and delivery driver profile until the data is transmitted from the database 125 to the server 135 over the communication network 130.

According to various embodiments, the system 100 may be connected by the communication network 130. The communication network 130 may comprise any suitable system for exchanging data, such as the Internet, off-line communications, wireless communications, and/or the like.

It will be appreciated that for security reasons, any databases, systems, and/or components of the present technology may comprise any combination of databases or components at a single location or at multiple locations, wherein each database or system includes any of various suitable security features, such as firewalls, access codes, encryption, de-encryption, compression, decompression, and/or the like.

According to various embodiments, the server 135 may be communicatively linked to the database 125 over the communication network 130, such that the server 135 may be accessed by the food provider. The server 135 may be configured to receive the customer data, customer profile, delivery driver data, and delivery driver profile from the database 125. Once the customer data, customer profile, delivery driver data, and delivery driver profile are received by the server 135, the customer data, customer profile, delivery driver data, and delivery driver profile may be accessed through any suitable user profile module. The user profile module may be accessible via any suitable mobile device interface and/or web portal and may be presented on the display 140. In some embodiments, the server 135 may be provided with selective access to the customer data, customer profile, delivery driver data, and delivery driver profile such that the customer data, customer profile, delivery driver data, and delivery driver profile may only be accessed by one or more designated system administrators.

Each system administrator may manage data associated with its respective restaurant, chef, market, food truck, and the like and may perform a variety of operations through the mobile device interface and/or web portal. For example, each system administrator may access the user profile module and any other module of the system 100 through the mobile device interface and/or web portal. Each system administrator may view orders, manage deliveries, and more.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connections and points of contact shown in the various FIGURES are intended to represent exemplary physical relationships between the various elements. Many alternative or additional functional relationships or physical connections may be present in a practical system.

Embodiments of the present technology may be used in conjunction with any number of methods and devices for optimizing a delivery process. In the foregoing description, the technology has been described with reference to specific exemplary embodiments. Various modifications and changes may be made, however, without departing from the scope of the present technology as set forth. The description and FIGURES are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages, and solutions to problems have been described above with regard to particular embodiments. Any benefit, advantage, solution to problems or any element that may cause any particular benefit, advantage, or solution to occur or to become more pronounced, however, is not to be construed as a critical, required, or essential feature or component.

The terms “comprises,” “comprising,” or any variation thereof, are intended to reference a non-exclusive inclusion, such that a system, process, method, article, composition, or apparatus that comprises a list of elements does not include only those elements recited but may also include other elements not expressly listed or inherent to such system, process, method, article, composition, or apparatus. Other combinations and/or modifications of the above-described structures, arrangements, applications, proportions, elements, materials, or components used in the practice of the present technology, in addition to those not specifically recited, may be varied, or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology.

1. A system for optimizing a delivery process, comprising:
a user device configured to receive customer data and delivery driver data;
a ranking engine configured to:
compute a plurality of rank scores according to the customer data and the delivery driver data; and
generate a plurality of customer profiles and a plurality of delivery driver profiles according to the customer data and the delivery driver data, respectively;
store the plurality of delivery driver profiles and the plurality of rank scores in a database;
a delivery driver management platform communicatively linked to the ranking engine;
a server communicatively linked to the database over a communication network, wherein the server is provided with access to the plurality of customer profiles, the plurality of delivery driver profiles, and the plurality of rank scores; and
a display configured to present the plurality of delivery driver profiles according to the plurality of rank scores.

2. The system of claim 1, wherein:
the customer data comprises:
a plurality of first distances, wherein each first distance is equal to a distance between a pickup location and a delivery location;
a plurality of customer payment information;
a plurality of customer contact information; and
a plurality of desired service requests; and
the delivery driver data comprises:
a plurality of second distances, wherein each second distance is equal to a distance between the real-time geographic location of one of the plurality of delivery drivers and the pickup location; and
a plurality of mileage rates.

3. The system of claim 2, wherein the delivery driver management platform is further configured to:
receive the customer data;
transmit the customer data to the ranking engine;
receive the plurality of rank scores from the ranking engine;
compare the plurality of rank scores;
assign the plurality of rank scores to the plurality of driver profiles; and
transmit the plurality of delivery driver profiles and the plurality of rank scores to the display; and
receive a customer request.

4. The system of claim 3, wherein the delivery driver management platform is further configured to receive the customer data and transmit the customer data to the ranking engine prior to receiving the customer request.

5. The system of claim 2, wherein the ranking engine is further configured to compute the plurality of rank scores based on at least one of a plurality of factors comprising:
the plurality of first distances;
the plurality of second distances;
the plurality of mileage rates;
a plurality of traffic conditions between the pickup location and the delivery location; and
a plurality of weather conditions between the pickup location and the delivery location.

6. The system of claim 5, wherein the ranking engine is further configured to assign a plurality of number values to the plurality of factors, and wherein each factor is assigned a number value comprising at least one of a first number, a second number value, a third number value, or a fourth number value.

7. The system of claim 6, wherein each rank score is equal to a weighted average sum of the plurality of number values.

8. The system of claim 7, wherein each number value is assigned a respective one of a plurality of weighted values, and wherein the plurality of weighted values are predetermined.

9. The system of claim 5, wherein the computed rank score comprises at least one of a low rank score relative to a reference rank score, a medium rank score relative to the reference rank score, or a high rank score relative to the reference rank score, and wherein:
the low rank score indicates a mismatch between the plurality of desired service requests and a capability of the delivery driver to meet the desired service requests.
the medium rank score indicates a moderate match between the plurality of desired customer requests and the capability of the delivery driver to meet the desired service requests; and
the high rank score indicates a strong match between the plurality of desired customer requests and the capability of the delivery driver to meet the desired customer requests.
